(19) United States
(12) Patent Application Publication
(10) Pub. No.: US 2009/0204881 A1
(43) Pub. Date: Aug. 13, 2009

(54) METHOD AND SYSTEM FOR KNOWLEDGE-BASED FILLING AND VERIFICATION OF COMPLEX FORMS

(75) Inventors: Kolluru Venkata Sreerama MURTHY, Hyderabad (IN); Bhairavi Tushar JANI, Mumbai (IN)

Correspondence Address: BIRCH STEWART KOLASCH & BIRCH, PO BOX 747, FALLS CHURCH, VA, 22040-0747, US

(73) Assignee: M/s. Scmooth (India) Private Limited, Hyderabad (IN)

(21) Appl. No.: 12/368,046

(22) Filed: Feb. 9, 2009

(30) Foreign Application Priority Data
Feb. 8, 2008 (IN) 339/CHE/2008

(51) Int. Cl. G06F 17/25

(52) U.S. Cl. 715/226

(57) ABSTRACT

Filling forms is an activity, which finds its use in several day-to-day functions of any organization. The system of the present invention proposes the abstraction of the knowledge required to fill forms into a hierarchy containing three levels including form, process and domain knowledge. Such an abstraction caters to a variety of users with varying expertise, from the novice form-filling user to the expert. By encapsulating knowledge in this manner, the system of the present invention removes the complexity involved in the process of form-filling. Further, methods are proposed within the present invention to automatically fill and verify forms, used for a variety of end-uses.

### FIELD OF THE INVENTION

This invention relates to a system and method for knowledge-based filling and verification of forms, which typically have a plurality of fields.

### DISCUSSION OF PRIOR ART

Forms are used for a variety of end-uses in various day-to-day activities, transactions and processes and are typically used to gather information about a certain process or entity. Since many of the activities involving forms are part of a computerized system, a data-entry operator or end-user ends up having to enter the data pertaining to the various fields in a form. Forms can be either simple or complex depending on the number of attributes they represent. Filling forms is a tedious process and the correctness of the outcome depends on the data-entry operator or end-user being alert and knowledgeable, and entering the correct information. Complex forms refer to forms, which represent several attributes whose values are occasionally inter-dependent and dependent on some external domain knowledge. Furthermore, complex forms require a greater level of error-control when they are filled out. Automating parts of the process of filling and verification of these complex forms is required in order to assist in retaining the quality of data-entry across both novice and experienced data-entry operators or end-users. Systems involving databases to store forms, one or more software modules to automate, correct, verify and assist in filling forms could be used in tandem to achieve such automation.

U.S. Pat. No. 6,088,700 proposes Automated forms completion for global information network applications and focuses on auto-filling of forms displayed on Web browsers of users. Companies can register their forms with this system. The system recognizes common and uncommon fields, and retrieves information from its database to auto-complete known fields while the user is browsing. U.S. Pat. No. 6,910,179 B1 proposes a Method and apparatus for automatic form-filling which describes a Browser Automation Tool that stores data in a database, monitors web forms appearing on the browser (whether or not such forms were pre-registered), and pops up help screens that have auto-fill suggestions for basic data. U.S. Pat. No. 6,460,042 B1 proposes a Universal forms engine wherein a user, for instance a college student, has to fill multiple application forms, all with more or less similar data and fields, but possibly widely varying appearances. This invention allows users to fill things once on one registered form, and re-use it on any number of other registered forms. U.S. Pat. No. 7,203,699 B2 proposes a Computerized system for automated completion of forms and focuses on filling of paper forms, by scanning them, converting to an electronic image, mapping fields to a database and auto-filling. U.S. Pat. No. 6,192,380 B1 discloses an Automatic web based form fill-in that is able to recognize a form on a web page automatically, authenticate it, fill in the values for every field that can be filled in from a database. U.S. Pat. No. 6,662,340 B2 discloses a Client-side form filler that populates form fields based on analyzing visible field labels and visible display format hints without previous examination or mapping of the form wherein given a web form, the invention is able to identify text labels and other visual information, to parse and arrive at what user profile information should be filled where, in which format. U.S. Pat. No. 6,434,547 B1 proposes a Data capture and verification system in a context very different from form-filling, this invention maintains knowledge related to specific parts of the document, and uses that knowledge to improve data capture and validation. U.S. Pat. No. 5,805,159 describes Mobile client computer interdependent display data fields, which are predictive widgets, i.e., small programs that may have encapsulated knowledge about a limited domain, e.g., US postal zip codes. U.S. Pat. No. 6,490,601 B1 proposes a Server for enabling the automatic insertion of data into electronic forms on a user computer in the context of banking wherein data is retrieved from a private server and inserted into a web-form. U.S. Pat. No. 6,981,028 B1 proposes a Method and system of implementing recorded data for automating Internet interactions, which enables easy recording and retrieval of login and registration information for multiple web sites. U.S. Pat. No. 6,026,187 discloses a System for automatically filling an original form wherein there is print-filling a physical form. U.S. Pat. No. 6,499,042 discloses a selective proxy approach to filling-in forms embedded in distributed electronic documents, which relates to giving capability to an entity to automatically release personal information to another entity connected over a network. U.S. Pat. No. 7,185,271 B2 proposes Methods and systems for implementing auto-complete in a web page including a method and systems for implementing auto-completion of web-pages. U.S. Pat. No. 6,199,079 B1 March 2001 proposes a Method and system for automatically filling forms in an integrated network based transaction environment which describes a method to enable a user shopping for items from different vendors' web sites, to automatically fill in order forms and then to purchase these items without having to browse and interact with different sites

Several patents proposed in the prior art aim at reducing redundancy experienced by the data-entry operator or end-user, while filling up forms. Most of them present the users with a facility to fill the forms once, store the forms in a database, and retrieve the forms when they are required for reuse. The major differences amongst the patents proposed in prior art are the actual forms they aim at filling, the maintenance of the databases, extent to which they auto-fill, etc. The present invention overcomes the limitations of the prior-art by proposing a knowledge-based and self-learning form-filling and verification system, which is able to handle and assist in the filling of complex forms across users of varying expertise.

### SUMMARY OF THE INVENTION

The present invention proposes a modular, light-weight system comprised of entities, interactions and users, which enables automatic form-filling and verification by encapsulating the knowledge required to fill forms into three hierarchical components of (a) form knowledge (b) process knowledge and (c) domain knowledge wherein one or more end-users and administrators who fill out forms and receive assistance from the system. The present invention further has means to assimilate data into a database or knowledge base from a variety of local and remote sources in one or more formats. The system of the present invention encapsulates knowledge in abstract units of form knowledge, process knowledge and domain knowledge wherein the form knowledge includes: (a) Information pertaining to the layout of the form, (b) Information pertaining to the fields; and (c) Information pertaining to static portions within the form. Process knowledge includes (a) Information pertaining to entities; (b) Information pertaining to interactions; and (c) Information pertaining to attributes. Finally, domain knowledge includes specific knowledge applicable to the field within which forms are used, for example, shipping, import-export, tax filing, excise, insurance, etc. The system of the present invention further comprises means to fill one or more forms with values for different fields in the form; and means to verify whether the values of the form have been filled correctly.

The present invention further proposes a method which enables automatic form-filling and verification by encapsulating the knowledge required to fill forms into three hierarchical components of (a) form knowledge (b) process knowledge and (c) domain knowledge comprising the steps of:
a. Assimilating data into a database or knowledge base from a variety of local and remote sources in one or more formats;
b. Encapsulating form knowledge including:
   i. Information pertaining to the layout of the form;
   ii. Information pertaining to the fields; and
   iii. Information pertaining to static portions within the form.
c. Encapsulating process knowledge including:
   i. Information pertaining to entities;
   ii. Information pertaining to interactions; and
   iii. Information pertaining to attributes.
d. Encapsulating domain knowledge including:
   i. Specific knowledge applicable to the field within which forms are used, for example, shipping, import-export, tax filing, excise, insurance, etc.
e. Filling one or more forms with values for different fields in the form; and
f. Verifying whether the values of the form have been filled correctly.

### BRIEF DESCRIPTION OF DRAWINGS

FIG. 1 shows the hierarchy of knowledge set out for filling complex forms.

FIG. 2 depicts examples of process knowledge, which are used in the domain of importing.

FIG. 3 depicts a sample complex form, namely a Bill of Lading, used in the domain of import/export.

FIG. 4 shows architectural elements of the proposed system.

FIG. 5 gives a flowchart for the smart form-filling process.

FIG. 6 shows how the master tables are utilized in the present invention.

FIG. 7 gives a flowchart for the smart form verification process.

FIG. 8 shows how the knowledge base in the proposed system is updated from third party data sources

### DETAILED DESCRIPTION OF PREFERRED EMBODIMENTS

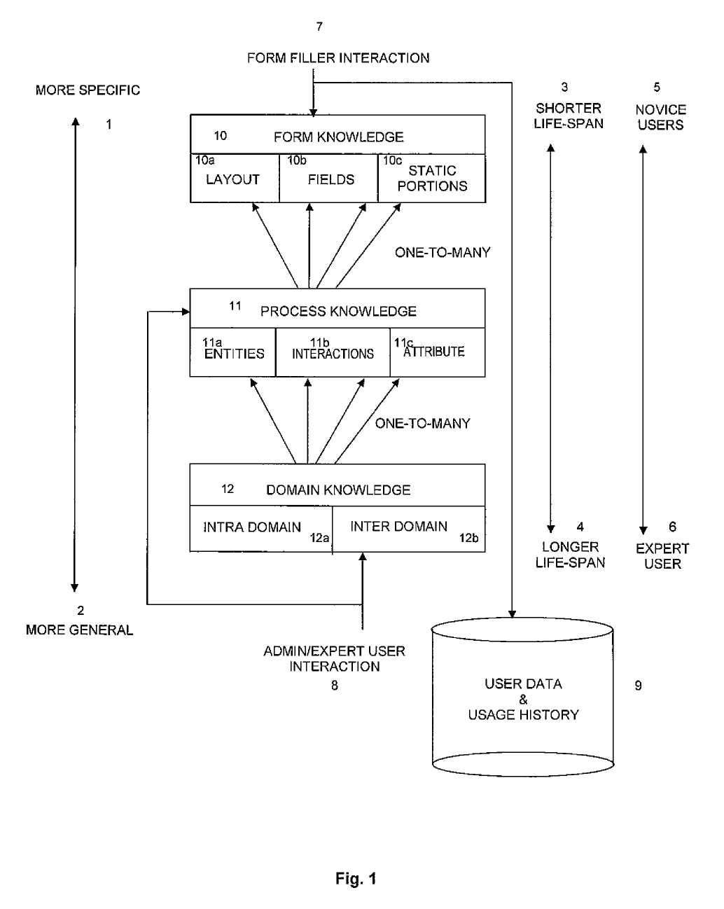

Filling forms is an activity common across many fields and in the modern day, a lot of these form-filling activities are carried out using computerized systems. As the complexity (in terms of number of fields or the knowledge of the entry-operator required) of the forms increases, there is an increased need to build in processes within the systems used for form-filling to enable the forms to be filled quickly and correctly. The present invention proposes to encapsulate the knowledge required in the form-filling process in order to allow any user, novice or expert, to effectively participate in the form-filling activity. The knowledge is encapsulated as domain knowledge, process knowledge and form knowledge and represents an abstraction that extends across data with varying life-spans, users with varying expertise and information with varying specificity. FIG. 1 shows the knowledge hierarchy and abstraction used in the present invention. The abstraction used in the present invention seeks to represent information, which is more specific 1 to more general 2. Further, the data that is represented within the form-filling process can have a short life span 3 or a long life span 4. The users of the system can be novices 5 or experts 6. Typically, two classes of users interact with the system of the present invention including the form filler 7 and the administrator or expert user 8. The form filler 7 typically interacts with a certain degree of form knowledge 10. Interactions of the form filler 7 get stored in the system as user data and usage history 9 while filling multiple forms. The expert user 8 typically interacts with process knowledge 11 and domain knowledge 12. The expert user 8 is the entity who is aware of the overall processes that are being captured by the various forms and further has in-depth knowledge of the domain. For examples, a customs supervisor would have in depth knowledge of the import/export processes and domain, when compared to a data-entry operator working for a small company. Over and above the classification or abstraction of knowledge into form knowledge 10, process knowledge 11 and domain knowledge 12, the system of the present invention segregates each of these classes or abstractions further, to effectively assist in filling forms. Form knowledge 10 is further divided into layout 10a, fields 10b and static portions 10c. Layout 10a of a form includes such information as the physical dimensions of the form and fields, sequence and physical organization of the fields, a unique name or id for each component (for connecting to other types of knowledge subsequently), the type of the component (e.g., text boxes, fill-in-blanks, radio buttons), inclusion of a particular form or sub-form inside another form, number and order of pages in the form, etc. Physical layout information is stored in the database primarily using geometric location of components, e.g., coordinates and sizes of rectangles. Layout knowledge is the most superficial, most specialized (as opposed to general-purpose) knowledge about a form. Changes in the layout, for example, shuffling components around, enlarging the size of components or even removing some components, seem to have little effect on the effectiveness of human users filling the form. Human users are able to fill the form as though nothing happened even when the layout of the form changes substantially. Any system to automatically fill complex forms should also be endowed with this quality, which is being achieved in this invention through maintaining Layout knowledge separately from other deeper levels of knowledge.

Field 10b is any self-contained part of the form that needs to be filled. This knowledge includes such things as name of the field, description of what is to be filled in there, syntax of the field values (e.g., “alphanumeric string of length of minimum one character and maximum 10 characters”). Field 10c is any static text on the form, such as field labels, instructions, titles, etc and its organization.

Process knowledge is further divided into entities 11a, interactions 11b and attributes 11c. Domain knowledge 12 refers to the knowledge within the domain, for example rules and regulations within the realm of import/export etc. Domain knowledge 12 could be both within the domain (intra-domain) 12a or across multiple domains (inter-domain) 12b.

Domain knowledge is the knowledge that an experienced practitioner in the domain is expected to have implicitly. This includes knowledge of processes and players in the domain, nature of interactions in the domain, volatility and reliability of specific pieces of information in the domain, standard information sources, geographic, temporal, cultural and other variations in domain practices, alternatives, short cuts and tricks for getting things done, interrelations between their domain (e.g. shipping) and other domains (e.g. banking), turnaround times, etc. In essence, all knowledge that a human who is filling complex forms uses which is not specific to that form or that particular process is grouped as domain knowledge in this invention. Domain practitioners familiar with the state of the art may be able to expand on specific constituents elucidated above.

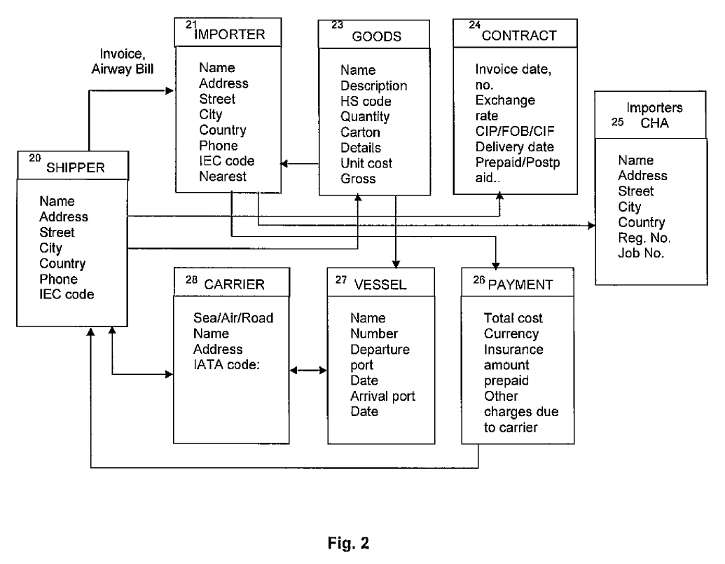

Process knowledge 11 along with entities 11a, interactions 11b and attributes 11c, is further elaborated in FIG. 2 by way of an example. Several entities such as shippers 20, importers 21, goods 23, contracts 24, importers customs house agent (CHA) 25, payment details 26, vessels 27 and carriers 28 play a role in the importing of goods across borders. Each of these entities has attributes associated with them as shown in FIG. 2.

Furthermore, the entities interact with each other by means of a standard set of interactions and are encapsulated in the abstractions within the system of the present invention. Sample interactions between entities in FIG. 2 can be a Shipper sending some Goods to an Importer through a CHA using a particular Carrier and Vessel.

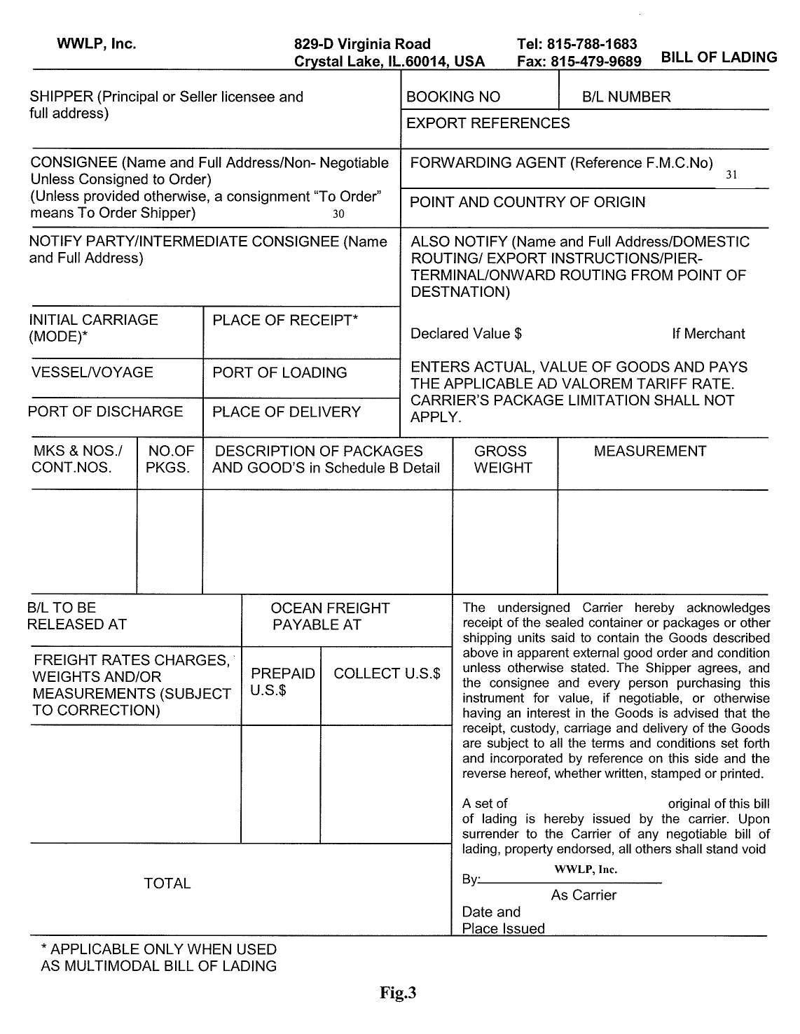

FIG. 3 gives an example of a complex form, namely a Bill of Lading, used in the domain of import/export. In this particular form, layout details would pertain to the placement of the shipper, consignee and party notification fields in one section 30 and the booking number, bill number and export references in the adjoining section 31. The fields of the form are listed in Table 1.

TABLE 1

| Field Name | Description |
|---|---|
| Shipper | Name of the shipper |
| Consignee | Name and address of the consignee |
| Notify Party/Intermediate | Name and address of intermediate party |
| Consignee | to notify the consignment |
| Booking No. | Reference No. of booking |
| Export References | Reference No. of export |
| Forwarding agent | References of agent |
| Point and country of origin | Details of point of dispatch |
| Also notify | Domestic routing instructions |
| Declared value | Value of the consignment |
| Consignment No | Serial No. of the consignment |
| No. of packages | No. of packages of the consignment |
| Description | Description of goods in packages |
| Weight, measurement | Weight and/or measurement of the goods/ |
| | packages |
| Rates, charges | Freight Rates and charges |
| Prepaid US $ | Amount prepaid for the service |
| Collect US $ | Balance amount to be paid for the service |
| Total | Total amount |
| Date and Place | Date and Place of issue |
| By | Seal of the carrier |

The system of the present invention effectively demarcates the knowledge required to fill complex forms, thereby enabling an effective process to auto-fill forms, while putting forth a simple user-interface.

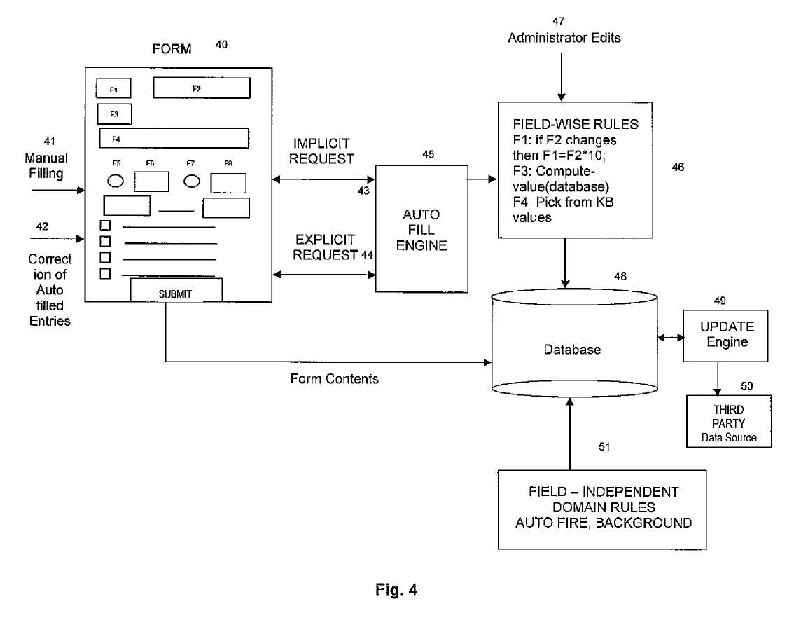

FIG. 4 shows the architectural elements of the system of the present invention. A form 40 can be filled manually by a user 41 and corrected by a user 42. The user can request that the form be filled automatically either implicitly 43 or explicitly 44. Implicit request happens when a user tries to manually fill a field and the system suggests a suitable value automatically. Explicit request could be, for example, by pressing a button named “Auto Fill Form”. This request is handled by an auto-fill engine 45, which maintains field-wise rules 46, which can be edited by an administrator 47. Examples of such rules include the ones listed in Table 2.

TABLE 2
Auto-fill engine rules

| Precedents | Antecedents |
|---|---|
| If F2 changes | F1 = F2*10 |
| F3 | Compute value (database) |
| F4 | Pick value from knowledgebase |

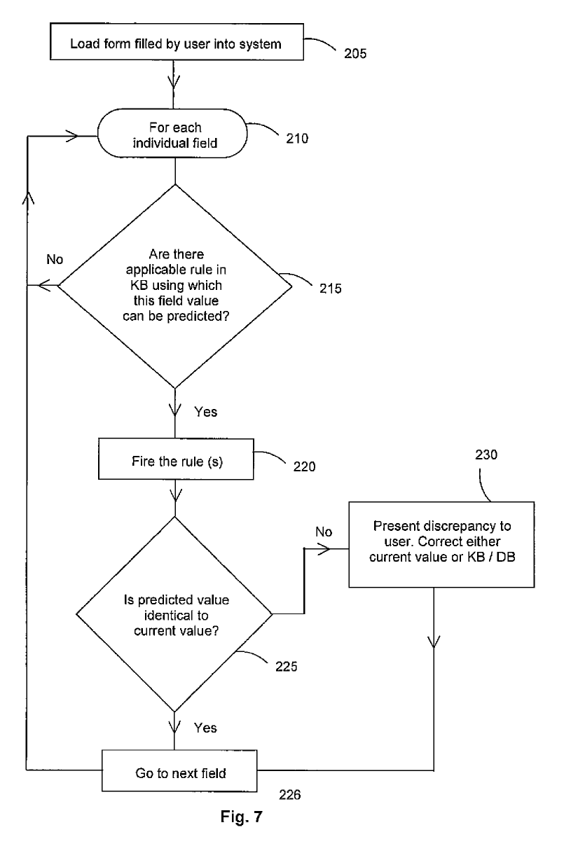

The contents of the form 40 are stored along with the rules 46 in a database 48. An update engine 49 works independently on the database to put in third-party updates 50 such as exchange rates for billing etc. This is described in more detail in FIG. 7. There could additionally exist field-independent domain rules 51 such as “whenever goods are imported, an import duty needs to be paid which will depend on the notifications issued by the Customs department of the importing country about that particular good.”

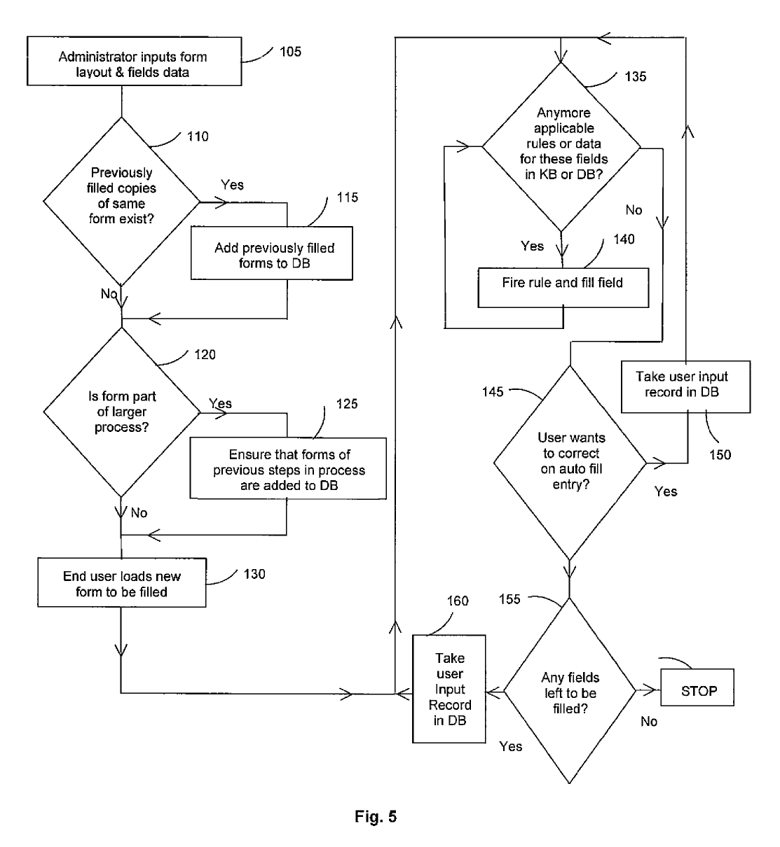

FIG. 5 shows the method of form-filling wherein initially the administrator inputs form layout and fields data 105. This is followed by a check to verify whether previous filled copies of the same form exist 110. If so, the previously filled forms are added to the database 115. A further check is performed to see whether the filling of this particular form is a step in a series of steps in a larger process 120. If so, the system ensures that forms of previous steps in the process are also added to the database 125. This is because some of the earlier forms may have information that can be auto-filled into the current form. The end-user is then prompted to enter details pertaining to a new form to be filled 130. For each field in the new form, the proposed system does a quick check to see if any further applicable rules or data for these fields exist in the knowledge base or database 135. Is so, the rules are executed to fill the field 140 and the check 135 is performed iteratively for each field. Rules may also specify order of firing or priority. One field may have zero, one or more rules applicable to it. Each rule has some antecedents and some result clauses. They are in the form “If condition 1 and condition 2 then result 1”. They can also be in the form of a calculation or a function. Once some entry is auto-filled, a check to see whether the user wants to correct an auto-filled entry 145 is performed. If so, the user input is taken on record onto the database 150. Next time when auto-fill is attempted for the same field (in this form or elsewhere), system response will be influenced by this user-filled value 150. A check to see if any remaining fields are to be filled 155 is then performed. If not, the method ends and if so, the user input record is taken into the database 160.

In the present invention, a field's value in a form may be filled in any of the ways listed below:
1. The user manually fills in the value of the field.
2. The field's value can be calculated from the values of already filled fields, using a domain-specific formula, which is stored in the knowledge base. E.g., Present Market Value (PMV) of an item
   i. A special case is when the value of the form field is the same as that of another field in the same or a different form
3. The user may need to select it from a set of pre-defined values, which exist in the knowledge base. E.g., name of a port in Argentina and its port-code
4. The field's value may be arrived at based on a domain rule. E.g., “If the Nature of Contract is CF, then no value is needed for Insurance amount.”
5. The field's value may be accessed from past or historical user data. E.g., PAN number of a known exporter

The extensive knowledge base of the present invention supports all these types of fields. The form-filling process is designed in such a way as to minimize the amount of time needed for filling the form. In case if the user manually filling the form, the present invention makes available to the user an efficient method to search and sub-set historic user data. The system maintains dependency lists between fields of a form. For example, when exporter name changes, then exporter address, IEC code and PAN number are also likely to change. Hence, the system maintains the exporter's address, IEC Code and PAN number fields in the dependency list of Exporter Name field. Whenever a particular field is filled by the user, plausible sets of values for fields dependent on it are re-extracted from historic user data in a context-sensitive manner.

For fields for which historic data suggests unique values (e.g., PAN Number of a known Exporter), the system fills the value in the form automatically. The system further has means to differentiate the filed values filled out by the system versus those entered by the user by using different colors etc. For other fields, a small set of plausible values are extracted from historic data, based on the dependency lists and the user is shown this subset of values to choose from.

In case the user rejects a smart suggestion given by the system and provides an alternate value, the system remembers the user-provided value and next time uses it to influence the smart suggestions. The smart suggestions are also ordered intelligently in order to minimize selection time for the user.

In the case where field values are calculated, the system maintains in the knowledge base, functions to compute all calculation fields. These functions are triggered when user's focus comes to the particular fields. In the case where the field values are picked from the knowledge base, the system's extensive knowledgebase maintains several predefined value sets, for fields like port codes, units, duty rates, HS/RITC codes (Harmonized System of Codes, Revised Indian Trade Classification code), customs notifications, etc. In the case where the field values are calculated using domain rules, the system's rule base maintains domain rules to figure out the values of these fields. Rules are of the form “If <condition1> and/or <condition2> . . . then <filedaction1> and <fieldaction2>.” etc.

The present invention initially assimilates data/knowledge from one or more remote or local locations such that the data is assimilated over a networked environment, the data is cleansed and transformed to suit the internal specifications required, the data is extracted to perform data-entry, updates are scheduled for the system's data base from the various sources and information is assimilated into the system's master tables, seamlessly.

A system of claim 3 wherein means to assimilate data includes encrypting and securing the data to be entered into the system, then updating the system and its indices.

The cleansing and transformation of data can involve a significant manual component that allows changing the format of the data to fit the internal representation of the system, removing incomplete or unreliable data and computing certain new information from existing information. When data-extraction is performed, parts of the data that need to be integrated with the system's knowledge base or database and entering those parts into the system are identified. In performing scheduling, manual and automatic determination of such parameters as the periodicity of updating the system by determining the intervals at which the data or knowledge source should be polled for new information and the times at which synchronization should happen, are performed.

Assimilating information into master tables comprises identification of the association of various data into their unique master tables and correlating the data within master tables with the user's present form-filling activity, in order to provide a seamless design for retrieving appropriate data for auto-filling the forms thereby removing redundant entry by the users.

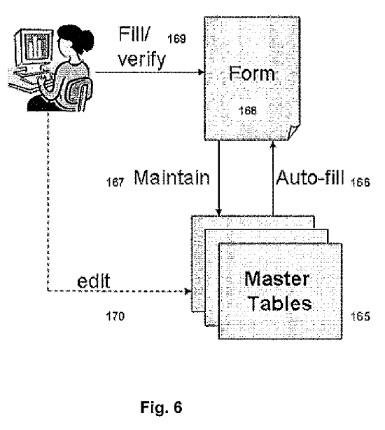

Normally form filling applications are designed such that the user fills in a set of master tables and the form gets generated from the data in the master tables. This is done to avoid repeat data entry. For example, to open a bank account, a banker may fill out client details such as name, address etc in a Customer Master table, client income details in Income Master and client account preferences in an Account Master. The bank account application form then gets generated from these tables. If the banker needs to fill another bank account opening form in future, the client's address details come from the Customer Master and need not be re-entered. While master tables avoid repeat data entry, they also imply additional work to input a single form. For example, to do one export invoice form, existing software requires filling up 8-12 master tables (8-12 screens worth of information). This needs not only time but also training on which master table holds what data. In the present invention, the system retains the advantages of master tables while removing the disadvantages of redundant entries. The software maintains the master tables automatically in the background in the present invention. The user directly fills one single export invoice form. The system knows which parts of the data should go into which master tables, and the same are stored appropriately. When the user attempts to fill a second invoice form, parts of this form get filled automatically from data which is already in background master tables. The user is not required to manage the master tables, so there is higher throughput and a shorter learning cycle. While there is no necessity to do so, if the user so desires, the proposed system also allows the user to directly manipulate the backend master tables. FIG. 6 shows how the master tables 165 are used to both auto-fill 166 and maintain 167 the forms 168. The forms are further filled/verified 169 by the user who can optionally edit 170 the master tables.

FIG. 7 shows an intelligent form verification method wherein the form filled by the user is first loaded into the system of the present invention 205. This is followed by a series of verification steps, performed for each individual field in the form 210. First, a check to see if there are any applicable rules in the knowledge base using which the field's value can be predicted is performed 215. Sequence of firing rules is important. This is followed by executing the rule 220, if the check yields a true value. This is followed by a check, to see whether the value predicted for the field in the form is identical to the value, which is populating the field, at the present time 225. If so, the next field is processed 226, if not the discrepancy is reported to the user and the correct value is entered into the knowledge base and database 230.

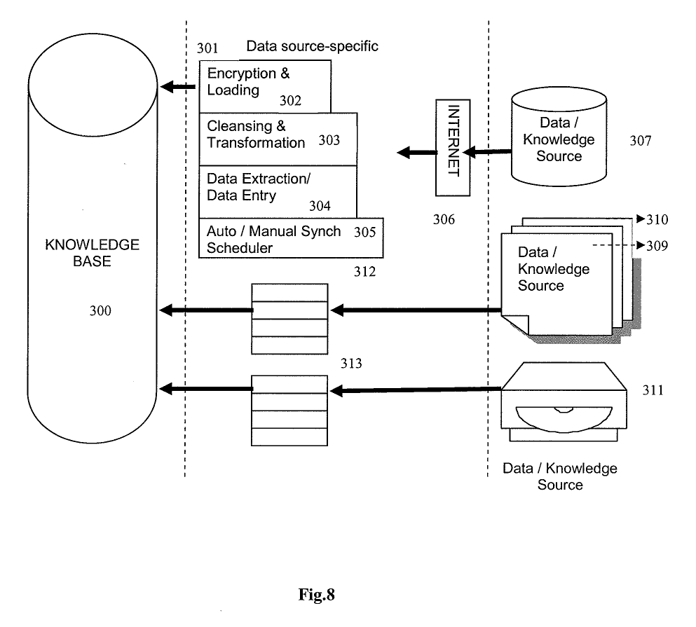

The system of the present invention can have its data-store updated from various digital pr physical sources. As shown in FIG. 4, the contents of the form 40 are stored along with the rules 46 in a database 48. An update engine 49 works independently on the database to put in third-party updates 50 such as exchange rates for billing etc. FIG. 8 elaborates on the data that can be obtained from external data-sources or digital media such as country-specific data, customs regulations that vary across countries, trade data, currency exchange rates, shipping schedules etc. The database of the present system, also referred to as the knowledge base 300 is updated from a variety of data or knowledge sources 307, 308, 309, 310, 311, that could be in any form, digital or otherwise. The knowledge base 300 can be updated via the Internet 306 or manually 312, 313. Several processes are executed 301 depending on the specific source of the data. These processes include encryption and loading 302, cleansing and transformation 303, data-extraction and entry 304 and scheduling 305. Loading 302 involves first the step of encrypting and securing the data to be entered into the system, then updating the system and its indices. Cleansing and transformation 303 involve changing the format of the data to fit the internal representation of the knowledge base, removing incomplete or unreliable data, and computing certain new information from existing information. Data transformation may involve a substantial manual component. Extraction 304 consists of identifying exactly what portions of the original data source need to be brought into the knowledge base 300, and copying or entering those portions of the data source. Scheduling 305 determines how often each data or knowledge source should be polled for new information, what times the synchronization should happen, etc. This may be done with manual intervention or by the system automatically.

We claim:

1. A modular, light-weight system comprised of entities, interactions and users, which enables automatic form-filling for forms that are used in various domains, comprised of one or more fields, and verification of these forms, by encapsulating the knowledge required to fill forms into three hierarchical components of (a) form knowledge (b) process knowledge and (c) domain knowledge comprising:
a. One or more end-users and administrators who fill out forms and receive assistance from the system;
b. Means to assimilate data into a database or knowledge base from a variety of local and remote sources in one or more formats;
c. Means to encapsulate form knowledge including:
i. Information pertaining to the layout of the form;
ii. Information pertaining to the fields; and
iii. Information pertaining to static portions within the form.
d. Means to encapsulate process knowledge including:
i. Information pertaining to entities;
ii. Information pertaining to interactions; and
iii. Information pertaining to attributes.
e. Means to encapsulate domain knowledge including:
i. Specific knowledge applicable to the field within which forms are used, including, shipping, import-export, tax filing, excise, insurance, etc.
f. Means to fill one or more forms with values for different fields in the form; and
g. Means to verify whether the values of the form have been filled correctly.

2. A system of claim 1 wherein form knowledge further comprises:
i. Layout information that includes:
1. The physical dimensions of the form and fields;
2. Sequence and physical organization of the fields;
3. A unique name or id for each field or component;
4. The type of the component details of static text on the form if any and its organization; and
5. Inclusion of a particular form or sub-form inside another form, number and order of pages in the form;
wherein the physical layout information is stored in the database primarily using geometric location of components, such as coordinates and sizes of rectangles wherein layout knowledge is the most superficial, most specialized knowledge about a form;
ii. Field information that includes:
1. Name of the field;
2. Description of what is to be filled in there; and
3. Syntax of the field values.
iii. Static portions that include static text on the form such as field labels, instructions and titles.

3. A system of claim 1 wherein process knowledge further comprises:
a. Entities, which are abstract units to represent the various parts of the process such as shippers, contracts, importers, payments and vessels;
b. Interactions, which are the data and control messages exchanged between various entities; and
c. Attributes, which are details relating to every entity.

4. A system of claim 1 wherein domain knowledge further comprises:
a. knowledge of processes and players in the domain;
b. nature of interactions in the domain;
c. volatility and reliability of specific pieces of information in the domain;
d. standard information sources;
e. geographic, temporal, cultural and other variations in domain practices;
f. alternatives, short cuts and tricks for getting things done;
g. interrelations between their domain and other domains; and
h. turnaround times.

5. A system of claim 1 where in means to assimilate data from one or more local or remote sources includes:
a. Means to assimilate data over a networked environment;
b. Means to cleanse and transform the data;
c. Means to extract the data and perform data-entry;
d. Means to schedule updates of the system's data base from the various sources; and
e. Means to assimilate information in master tables to collapse the master tables into one seamless flow.

6. A system of claim 3 wherein means to assimilate data includes encrypting and securing the data to be entered into the system, then updating the system and its indices.

7. A system of claim 3 wherein means to cleanse and transform can involve a significant manual component further including:
a. changing the format of the data to fit the internal representation of the system;
b. removing incomplete or unreliable data; and
c. computing certain new information from existing information.

8. A system of claim 3 wherein means to extract the data includes identifying which parts of the data need to be integrated with the system's knowledge base or database and entering those parts into the system.

9. A system of claim 3 wherein means to schedule includes determining both manually and automatically such parameters as:
a. The periodicity of updating the system by determining the intervals at which the data or knowledge source should be polled for new information; and
b. The times at which synchronization should happen.

10. A system of claim 3 wherein the means to assimilate information into master tables comprises:
a. Means to identify the association of various data into their unique master tables; and
b. Means to correlate the data within master tables with the user's present form-filling activity, in order to provide a seamless design for retrieving appropriate data for auto-filling the forms thereby removing redundant entry by the users.

11. A system of claim 1 wherein means to fill the form further includes:
a. Means to allow manual entry of the values of the fields in the form such that:
i. The user can implicitly or explicitly request automatic filling of the form wherein an implicit request is made when a user tries to fill out a value in the form and the system suggests possible options and an explicit request is made when a user specifically requests automatic filling;
ii. The manually entered values are differentiated from the automatically filled values by using different colors for easier verification; and
iii. The user is presented with an efficient method to search and sub-set historic data.
b. Means to check whether previously filled copies of the same form exist whereby the previously filled forms are fetched on demand and added to the database;
c. Means to check if the filling of the current form is part of a larger process whereby the forms from previous steps are also fetched on demand and added to the database;
d. Means to select the value of a field from a set of pre-defined values; and
e. Means to execute domain dependent (or auto-fill) and domain independent rules to arrive at the value of the field in a form wherein:
i. The rules have one or more antecedents and zero or more precedents associated with them wherein the precedent defines the condition upon which the rule is activated and the antecedent specifies the actual rule that is executed.

12. A system of claim 1 wherein the means to verify whether the values of the form have been filled correctly further comprises:
a. Means to loading the form filled by the user into the system;
b. Means to perform a series of verification steps on each individual field in the form including:
i. Checking to see if there are any applicable rules in the knowledge base using which the field's value can be predicted;
ii. Executing the rule if the check yields a true value; and
iii. Checking to see whether the value predicted for the field in the form is identical to the value which is populating the field, at the present time, if so, processing the next field and if not, reporting the discrepancy is reported to the user and entering the correct value into the knowledge base and database.

13. A system of claim 1 wherein the means to encapsulate form, field, process and domain knowledge can accept, process and output data from and to a variety of local and remote sources, over stand-alone digital media or networked environments, in a variety of formats including Microsoft Excel PDF, plain text formats.

14. A method which enables automatic form-filling for forms that are used in various domains, comprised of one or more fields, and verification of these forms, by encapsulating the knowledge required to fill forms into three hierarchical components of (a) form knowledge (b) process knowledge and (c) domain knowledge comprising the steps of:
a. Assimilating data into a database or knowledge base from a variety of local and remote sources in one or more formats;
b. Encapsulating form knowledge including:
i. Information pertaining to the layout of the form;
ii. Information pertaining to the fields; and
iii. Information pertaining to static portions within the form.
c. Encapsulating process knowledge including:
i. Information pertaining to entities;
ii. Information pertaining to interactions; and
iii. Information pertaining to attributes.
d. Encapsulating domain knowledge including:
i. Specific knowledge applicable to the field within which forms are used including shipping, import-export, tax filing, excise, insurance, etc.
e. Filling one or more forms with values for different fields in the form; and
f. Verifying whether the values of the form have been filled correctly.

15. A method of claim 14 wherein form knowledge further comprises:
i. Layout information that includes:
1. The physical dimensions of the form and fields;
2. Sequence and physical organization of the fields;
3. A unique name or id for each component (for connecting to other types of knowledge subsequently);
4. The type of the component (e.g., text boxes, fill-in-blanks, radio buttons), details of static text on the form if any and its organization; and
5. Inclusion of a particular form or sub-form inside another form, number and order of pages in the form;
wherein the physical layout information is stored in the database primarily using geometric location of components, e.g., coordinates and sizes of rectangles wherein layout knowledge is the most superficial, most specialized (as opposed to general-purpose) knowledge about a form;
ii. Field information that includes:
1. Name of the field;
2. Description of what is to be filled in there; and
3. Syntax of the field values.
iii. Static portions that include static text on the form such as field labels, instructions and titles.

16. A method of claim 14 wherein process knowledge further comprises:
a. Entities, which are abstract units to represent the various parts of the process such as shippers, contracts, importers, payments, vessels etc.;
b. Interactions, which are the data and control messages exchanged between various entities; and
c. Attributes, which are details relating to every entity.

17. A method of claim 14 wherein domain knowledge further comprises:
a. knowledge of processes and players in the domain;
b. nature of interactions in the domain;
c. volatility and reliability of specific pieces of information in the domain;
d. standard information sources;
e. geographic, temporal, cultural and other variations in domain practices;
f. alternatives, short cuts and tricks for getting things done;
g. interrelations between their domain and other domains; and
h. turnaround times.

18. A method of claim 14 wherein assimilating data from one or more local or remote sources includes the steps of:
a. Assimilating data over a networked environment;
b. Cleansing and transforming the data;
c. Extracting the data and perform data-entry;
d. Scheduling updates of the system's data base from the various sources; and
e. Assimilating information in master tables to collapse the master tables into one seamless flow.

19. A method of claim 14 wherein assimilating data includes encrypting and securing the data to be entered into the system, then updating the system and its indices.

20. A method of claim 14 wherein cleansing and transforming the data can involve a significant manual component further including:
a. changing the format of the data to fit the internal representation of the system;
b. removing incomplete or unreliable data; and
c. computing certain new information from existing information.

21. A method of claim 14 wherein extracting the data includes identifying which parts of the data need to be integrated with the system's knowledge base or database and entering those parts into the system.

22. A method of claim 14 wherein scheduling includes determining both manually and automatically such parameters as:
a. The periodicity of updating the system by determining the intervals at which the data or knowledge source should be polled for new information; and
b. The times at which synchronization should happen.

23. A method of claim 14 wherein assimilating information into master tables comprises:
a. Identifying the association of various data into their unique master tables; and
b. Correlating the data within master tables with the user's present form-filling activity, in order to provide a seamless design for retrieving appropriate data for auto-filling the forms thereby removing redundant entry by the users.

24. A method of claim 14 wherein the step of filling forms further comprises the steps of:
a. An administrator inputting form layout and fields data;
b. Checking to verify whether previous filed copies of the same form exist:
i. If so, adding the previously filled forms are added to the database;
c. Checking whether the filling of this particular form is a step in a series of steps in a process:
i. If so, the system ensuring that forms of previous steps in the process are added to the database;
d. Prompting the end-user to enter details pertaining to a new form to be filled;
e. Checking iteratively to see if any further applicable rules or data for these fields exist in the knowledge base or database wherein rules connect value one field with values of other field(s), through a calculation, a quantitative relation, an if-then rule or through a computer function or program:
i. If so, executing the rules to fill the field;
f. Checking to see whether the user wants to correct an auto-filled entry:
i. If so, taking the users input on record onto the database; and
ii. If not, checking to see if any remaining fields are to be filled:
1. If so taking the user input record is taken into the database; and
2. If not, the method ends.

25. A method of claim 14 wherein the step of verifying forms further comprises the steps of:
a. Loading the form filled by the user into the system;
b. Performing a series of verification steps on each individual field in the form including:
i. Checking to see if there are any applicable rules in the knowledge base using which the field's value can be predicted;
1. If the check returns a true value:
a. Executing the rule;
b. Checking to see whether the value predicted for the field in the form is identical to the value which is populating the field, at the present time:
i. If so, processing the next field; and
ii. If not, reporting the discrepancy is reported to the user and entering the correct value into the knowledge base and database;
2. If the check returns a false value, returning to step 25.b.
c. Halting the method when all the fields of the form have been addressed.

26. A method of claim 14 wherein filling the form further includes:
a. Allowing manual entry of the values of the fields in the form such that:
i. The user can implicitly or explicitly request automatic filling of the form wherein an implicit request is made when a user tries to fill out a value in the form and the system suggests possible options and an explicit request is made when a user specifically requests automatic filling;
ii. The manually entered values are differentiated from the automatically filled values by using different colors for easier verification; and
iii. The user is presented with an efficient method to search and sub-set historic data.
b. Checking whether previously filled copies of the same form exist whereby the previously filled forms are fetched on demand and added to the database;
c. Checking if the filling of the current form is part of a larger process whereby the forms from previous steps are also fetched on demand and added to the database;
d. Selecting the value of a field from a set of pre-defined values; and
e. Executing domain dependent (or auto-fill) and domain independent rules to arrive at the value of the field in a form wherein:
i. The rules have one or more antecedents and zero or more precedents associated with them wherein the precedent defines the condition upon which the rule is activated and the antecedent specifies the actual rule that is executed.

27. A method of claim 14 wherein the means to encapsulate form, field, process and domain knowledge can accept, process and output data from and to a variety of local and remote sources, over stand-alone digital media or networked environments, in a variety of formats including Microsoft Excel, PDF, plain text formats.
